(19) United States
(12) Patent Application Publication
(10) Pub. No.: US 2015/0002894 A1
(43) Pub. Date: Jan. 1, 2015

(54) Printing Apparatus, Computer-Readable Storage Medium Storing Program, and Method

(71) Applicant: Brother Kogyo Kabushiki Kaisha, Nagoya-shi (JP)

(72) Inventor: Toyoshi Adachi, Iwakura-shi (JP)

(73) Assignee: BROTHER KOGYO KABUSHIKI KAISHA, Nagoya-shi (JP)

(21) Appl. No.: 14/317,898

(22) Filed: Jun. 27, 2014

(30) Foreign Application Priority Data
Jun. 28, 2013 (JP) 2013-137306

(51) Int. Cl. G06F 3/12; H04N 1/00; G06K 15/02

(52) U.S. Cl. CPC G06F 3/1204; G06K 15/1809; G06F 3/1237; H04N 1/00411
USPC 358/1.15

(57) ABSTRACT

A printing apparatus includes a display device, a printing device, a processor, and memory that stores instructions therein. The instructions, when executed by the processor, cause the printing apparatus to perform steps comprising displaying a bookmark associated with a file on the display device; accepting designation of the bookmark displayed on the display device; obtaining image data of one or more pages from the file associated with the designated bookmark; and controlling the printing device to print the obtained image data.

### CROSS-REFERENCE TO RELATED APPLICATION

This application claims priority from Japanese Patent Application No. 2013-137306, filed on Jun. 28, 2013, which is incorporated herein by reference in its entirety.

### TECHNICAL FIELD

The disclosure relates to a printing apparatus, a computer-readable storage medium storing a program to be installed on the computer, and method.

### BACKGROUND

Recently, there has been provided a printing apparatus having a download and print function and/or a direct print function. The download and print function enables printing a file by downloading the file stored in a server to the printing apparatus directly. The direct print function enables printing a file by capturing the file stored in removable media, such as a USB memory, into the printing apparatus directly. Both the functions enable easy file printing without using a personal computer (“PC”).

### SUMMARY

There may be a case where a PDF file including a plurality of pages may be printed using the above-described printing apparatus. In such a case, when a user desires to print one or more of the plurality of pages of the file, the user may take the trouble to provide a print instruction after designating one or more print-target page numbers.

One illustrative aspect provides for a printing apparatus, a computer-readable storage medium storing a program, and method that may avoid the trouble associated with page designation printing.

According to an illustrative configuration, the bookmark included in the file may be displayed on the display device. Therefore, a user may identify the one or more pages to be printed by referring to the bookmark displayed on the display device. Further, the user may designate the bookmark corresponding to the one or more pages to be printed via the operation device. As the bookmark is designated, image data of the one or more pages corresponding to the designated bookmark may be printed. Accordingly, the trouble associated with page designation printing may be reduced.

### DESCRIPTION OF THE DRAWINGS

For a more complete understanding of the present invention, needs satisfied thereby, and the objects, features, and advantages thereof, reference now is made to the following descriptions taken in connection with the accompanying drawings.

FIG. 1 is a block diagram showing a configuration of a system including a multifunction peripheral (“MFP”) and an electrical configuration of the MFP in an illustrative embodiment according to one or more aspects of the disclosure.

FIG. 2 illustrates an example file selection screen displayed on an operation panel of the MFP in the illustrative embodiment according to one or more aspects of the disclosure.

FIG. 3A illustrates an example bookmark selection screen displayed on the operation panel in the illustrative embodiment according to one or more aspects of the disclosure.

FIG. 3B illustrates another example bookmark selection screen displayed on the operation panel in the illustrative embodiment according to one or more aspects of the disclosure.

FIG. 3C illustrates still another example bookmark selection screen displayed on the operation panel in the illustrative embodiment according to one or more aspects of the disclosure.

FIG. 4 illustrates an example first print-settings screen displayed on the operation panel in the illustrative embodiment according to one or more aspects of the disclosure.

FIG. 5 illustrates an example second print-settings screen displayed on the operation panel in the illustrative embodiment according to one or more aspects of the disclosure.

FIG. 6 is a flowchart showing steps in a display and print process in the illustrative embodiment according to one or more aspects of the disclosure.

FIG. 7 is a flowchart showing steps in a file selection process included in the display and print process in the illustrative embodiment according to one or more aspects of the disclosure.

FIG. 8 is a flowchart showing steps in a target selection process included in the display and print process in the illustrative embodiment according to one or more aspects of the disclosure.

FIG. 9 is a flowchart showing steps in a selection display process included in the target selection process in the illustrative embodiment according to one or more aspects of the disclosure.

FIG. 10 is a flowchart showing steps in a cancellation display process included in the target selection process in the illustrative embodiment according to one or more aspects of the disclosure.

FIG. 11 is a flowchart showing steps in a server process performed by a server in the illustrative embodiment according to one or more aspects of the disclosure.

FIG. 12 is a flowchart showing steps in a bookmark and page count data transmission process included in the server process in the illustrative embodiment according to one or more aspects of the disclosure.

FIG. 13 is a flowchart showing a target data transmission process included in the server process in the illustrative embodiment according to one or more aspects of the disclosure.

### DETAILED DESCRIPTION

Hereinafter, illustrative embodiments will be described in detail with reference to the accompanying drawings.

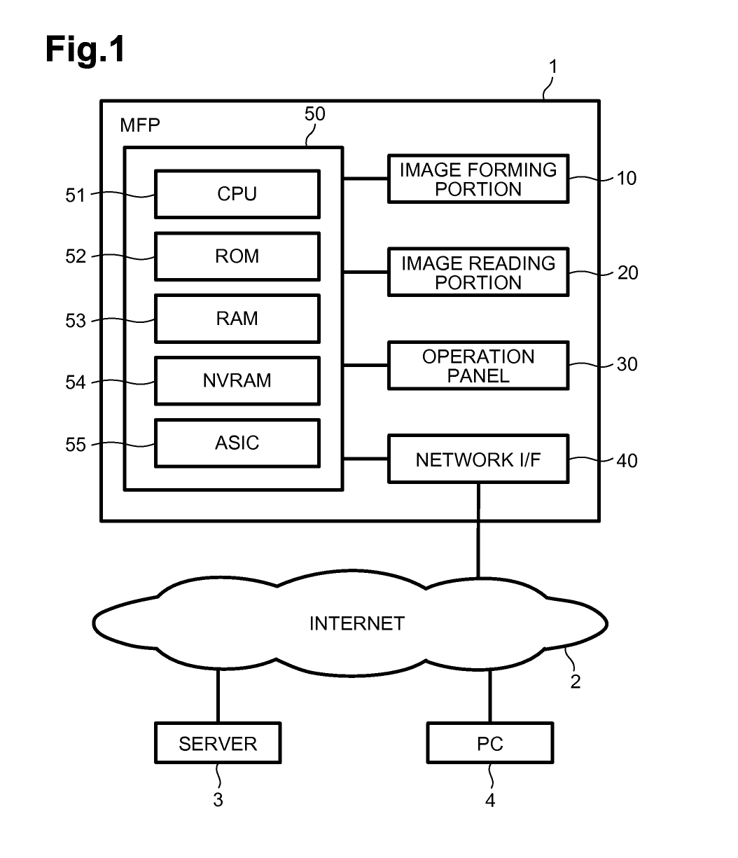

As shown in FIG. 1, a multifunction peripheral (“MFP”) 1 as an example of a printing apparatus comprises an image forming portion 10, an image reading portion 20, an operation panel 30, a network interface (“I/F”) 40, and a control device 50.

In the illustrative embodiment, the MFP 1 is taken as the example of the printing apparatus. Nevertheless, the printing apparatus may be any device having at least a print function, such as a device having the print function singly or a device having one or more other functions in addition to the print function.

The image forming portion 10 as an example of a printing device performs printing (e.g., color printing or monochrome printing) based on image data. Through the printing, an image is formed on a printing sheet. For the image formation method, one of an electrophotographic method and an inkjet method is used.

The image reading portion 20 reads an image from a document to generate image data. For the reading method, one of an automatic document feeder method (“ADF”) for reading an image from a document while conveying the document and a flatbed (“FB”) method for reading an image from a document while the document is placed on a contact glass is used.

The operation panel 30 as an example of a display device and an operation device comprises a touch panel and operation buttons. The touch panel displays various information thereon. Touch operations on the touch panel enable various inputs. The operation buttons comprise, for example, a plurality of function selection buttons for selecting a function to be used by the user and a cross-shaped button for changing a screen displayed on the touch panel.

The network interface 40 is connected to the Internet 2. Thus, the MFP 1 is allowed to perform communication via the Internet 2 with a server 3 connected to the Internet 2. The server 3 as an example of an external device offers a download service for transmitting one or more files stored in a memory to the MFP 1 via the Internet 2. The MFP 1 has a download and print function for printing one or more files by downloading the one or more files from the server 3 using the download service.

The control device 50 comprises a central processing unit (“CPU”) 51, a read-only memory (“ROM”) 52, a random-access memory (“RAM”) 53, a nonvolatile random-access memory (“NVRAM”) 54, and an application specific integrated circuit (“ASIC”) 55. The CPU 51 executes a program for various processes to control the image forming portion 10, the image reading portion 20, and the operation panel 30 and to control communication via the network interface 40. The ROM 52 stores the program performed by the CPU 51 and data necessary for the various processes. The RAM 53 is used as a workspace during performance of the program by the CPU 51. The NVRAM 54 stores various setting values to be inputted through the operation panel 30.

The operation panel 30 comprises a download-and-print function selection button as one of the function selection buttons.

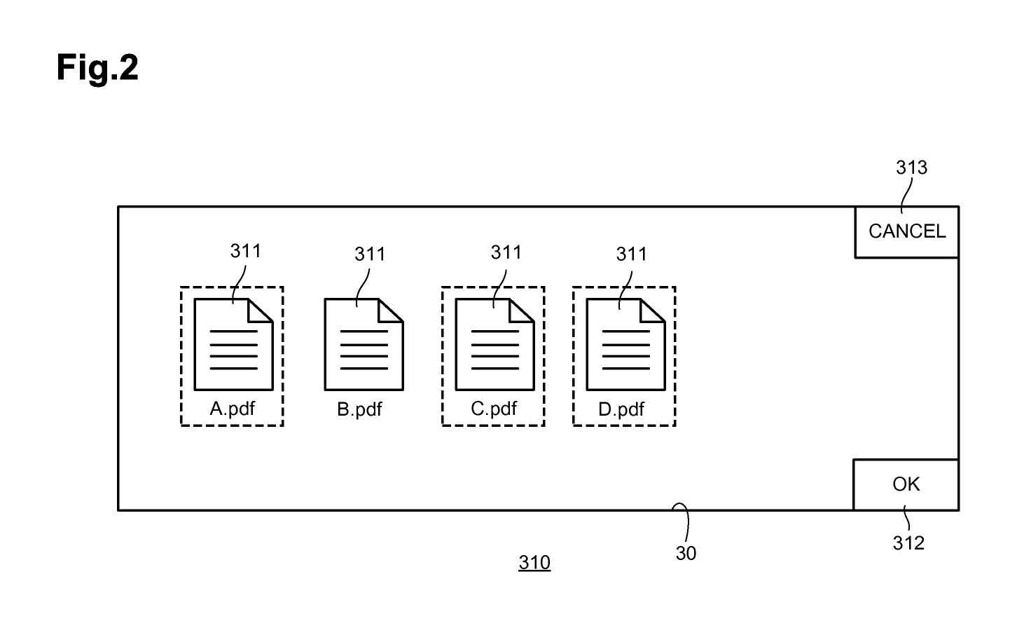

Upon pressing the download-and-print function selection button during display of an initial screen (not shown) on the touch panel of the operation panel 30, the screen displayed on the touch panel changes from the initial screen to a file selection screen 310. FIG. 2 illustrates an example of the file selection screen 310.

The file selection screen 310 allows selection and designation of one or more files to be printed (e.g., downloaded and printed) by the download and print function.

The file selection screen 310 displays a list of one or more files available for download and printing with one or more icons 311. The icons 311 include file names, respectively.

Each icon 311 changes between a state where a file is selected and a state where a selection of the file is cancelled (i.e., a state where a file is unselected) every time the icon 311 is touched. For example, in the state where a file is selected, an icon 311 representing the file is enclosed in a quadrangle indicated by a dashed line. In the state where the selection of the file is cancelled, the icon 311 of the file is not enclosed in the quadrangle indicated by the dashed line.

The example file selection screen 310 shown in FIG. 2 displays, side by side, icons 311 representing a PDF format file (“PDF file”) “A”, a PDF file “B”, a PDF file “C”, and a PDF file “D”, respectively, as the list of files available for download and printing. The file selection screen 310 shows a situation in which the PDF file “A”, the PDF file “C”, and the PDF file “D” are selected and the PDF file “B” is not selected.

The file selection screen 310 also displays an OK key 312 and a CANCEL key 313.

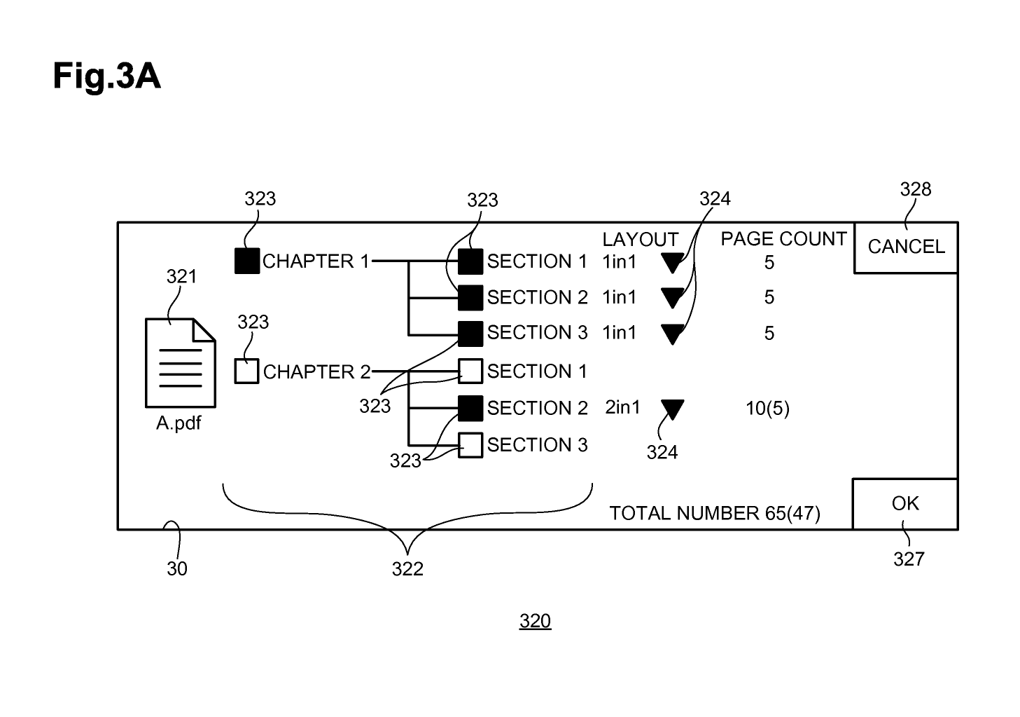

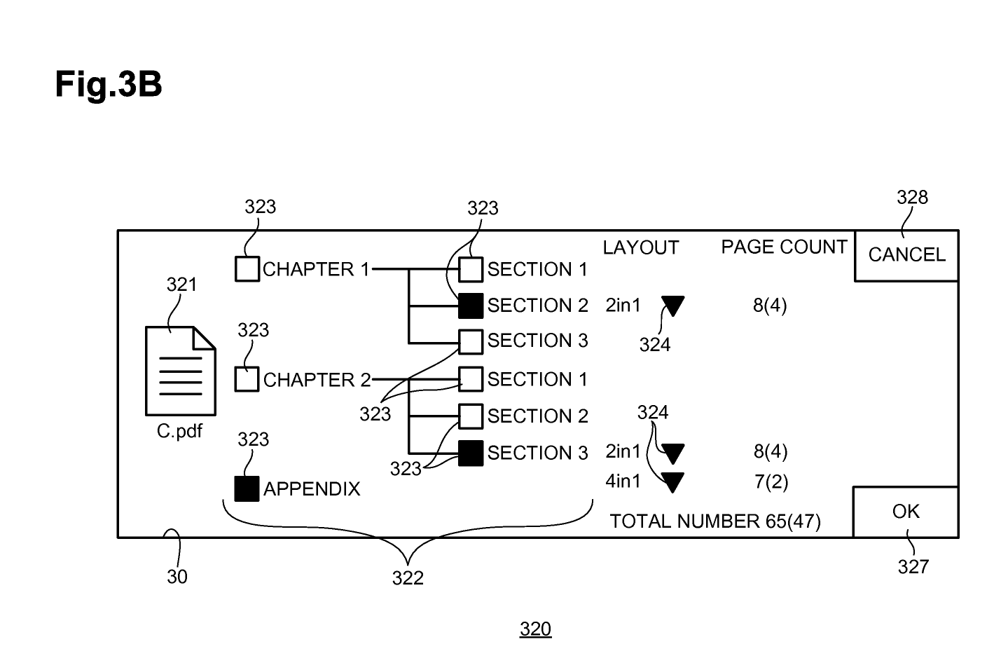

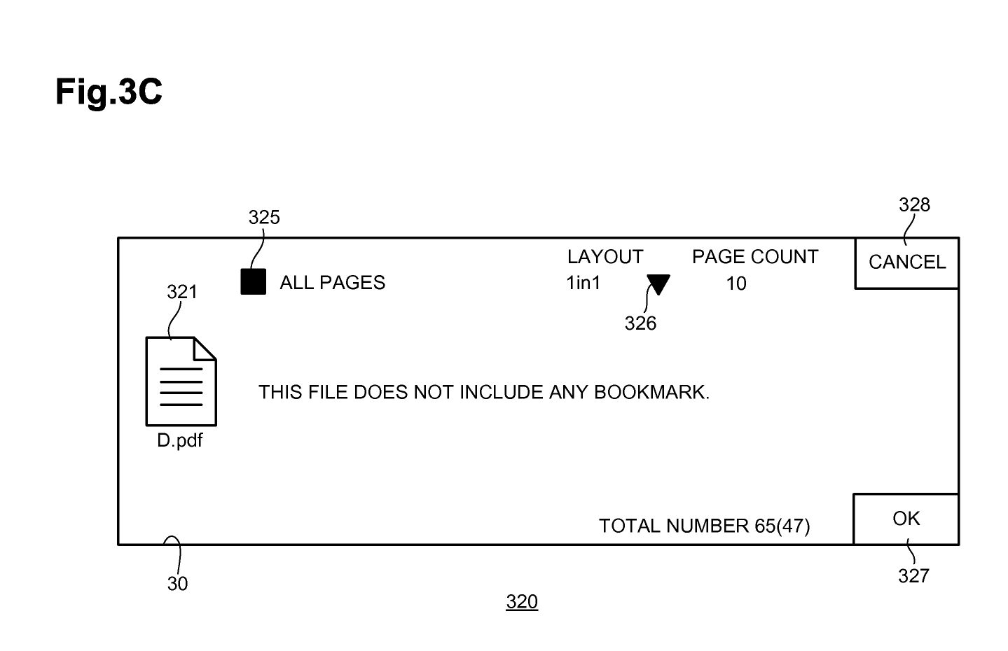

Upon touching the OK key 312 while one or more files are selected, the selection of the one or more files are finalized and thus the file designation (e.g., selection) is completed. Then, the screen displayed on the touch panel of the operation panel 30 changes from the file selection screen 310 to a bookmark selection screen 320 (see FIG. 3A).

Upon touching the CANCEL key 313, the screen displayed on the touch panel of the operation panel 30 returns to the initial screen from the file selection screen 310.

Hereinafter, a description will be made, by taking a case where the OK key 312 is touched while the PDF file “A”, the PDF file “C” and the PDF file “D” are selected, as an example.

The bookmark selection screen 320 and the file designated on the file selection screen 310 have a one-to-one correspondence therebetween. When a plurality of files is designated on the file selection screen 310, there are a plurality of bookmark selection screens 320. In this case, for example, in response to pressing one of an up directional key (not shown) and a down directional key (not shown) included in the cross-shaped directional key of the operation panel 30, the screen displayed on the touch panel changes among the plurality of bookmark selection screens 320. FIGS. 3A, 3B, and 3C illustrate bookmark selection screens 320 corresponding to the PDF file “A”, the PDF file “C”, and the PDF file “D”, respectively, as examples of the bookmark selection screen 320.

The bookmark selection screen 320 displays one or more icons 321 corresponding to the one or more files designated on the file selection screen 310. The icon 321 has the same design as the icon 311 shown in FIG. 2. The icon 321 is disposed at a far-left portion of the bookmark selection screen 320.

In a case where the file designated on the file selection screen 310 includes one or more bookmarks, the bookmark selection screen 320 corresponding to the file allows selection of one or more pages to be downloaded and printed from one or more pages included in the file, using the one or more bookmarks. In this case, the bookmark selection screen 320 displays a list of one or more bookmarks (e.g., a bookmark list) 322 included in the file, as shown in FIGS. 3A and 3B.

A bookmark is information that is helpful to the user when the user refers to and/or designates a particular page or a plurality of pages in a page group (e.g., a group of a plurality of consecutive pages) included in a file. For example, in a case where a file is a document file that represents a document arranged into chapters, a bookmark is generated for each group, such as each chapter and each section included in each chapter, and added to each page included in each group. More specifically, for example, in a case where a document represented by a document file includes “Chapter 1” and “Chapter 2”, bookmarks representing “Chapter 1” and “Chapter 2” are generated respectively. Then, the bookmark representing “Chapter 1” is added to each page included in “Chapter 1”, and the bookmark representing “Chapter 2” is added to each page included in “Chapter 2”. Further, in a case where “Chapter 1” includes “Section 1”, “Section 2”, and “Section 3”, bookmarks representing “Section 1”, “Section 2”, and “Section 3” are generated respectively. Then, the bookmark representing “Section 1” is added to each page included in “Section 1”, the Bookmark representing “Section 2” is added to each page included in “Section 2”, and the bookmark representing “Section 3” is added to each page included in “Section 3”.

The bookmark list 322 shows the bookmarks with respective titles that the user is able to identify the one or more pages. For example, in a case where a file is a document file that represents a document arranged into chapters, the bookmark list 322 shows bookmarks with respective titles of chapters and sections to which the bookmarks are added. Further, in a case where a file is a document file that represents a document arranged into chapters, the bookmark list 322 shows the bookmarks hierarchically in order for the user to understand the chapter arrangement structure (e.g., the hierarchical structure). In the above-described example, the bookmark list 322 shows the bookmarks representing “Chapter 1” and “Chapter 2”, respectively, and the bookmarks representing “Section 1”, “Section 2”, and “Section 3”, respectively, included in each chapter, with their chapter or section titles. The bookmark list 322 further shows the titles, such as “Chapter 1” and “Chapter 2”, in a tree structure in order for the user to understand that “Chapter 1” includes “Section 1”, “Section 2”, and “Section 3” and “Chapter 2” includes “Section 1”, “Section 2”, and “Section 3”.

In a case where a file is a document file that represents a document arranged into chapters, a bookmark may be generated for each group such as each chapter and each section included in each chapter, and may be added to a first page in each group. In this case, the MFP 1 identifies one or more pages included in each group based on the pages to which the bookmarks are added. For example, in a case where a first page in Section 2 is page 6 and a first page in Section 3 is page 16, the MFP 1 identifies pages 6 to 15 as pages included in Section 2.

In a case where a file is a document file that represents a document arranged into chapters, the file may or may not include tree information representing the chapter arrangement structure. In a case where the tree information is included in the file, the MFP 1 identifies the chapter arrangement structure based on the tree information. In a case where the tree information is not included in the file, the MFP 1 identifies the chapter arrangement structure based on the one or more bookmarks included in the file.

For example, a PDF file may include one or more pieces of data identifying bookmarks, e.g., “Parent”, “Next”, “Prev”, “First”, and “Last”, as tree information representing the chapter arrangement structure. The “Parent” is data that identifies a bookmark which belongs in one level higher than a level in which a reference bookmark belongs and to which the reference bookmark is subordinate. The “Next” is data that identifies a bookmark which belongs in the same level as a level in which a reference bookmark belongs and which is listed next to the reference bookmark in the level. The “Prev” is data that identifies a bookmark which belongs in the same level as a level in which a reference bookmark belongs and which is listed immediately previous to the reference bookmark in the level. The “First” is data that identifies a bookmark which belongs in one level subordinate to a level in which a reference bookmark belongs and which is listed as the top in the level. The “Last” is data that identifies a bookmark which belongs in one level subordinate to a level in which a reference bookmark belongs and which is listed as the last in the level. In this case, referring to the one or more pieces of data identifying the bookmarks, e.g., “Parent”, “Next”, “Prev”, “First”, and “Last”, the MFP 1 identifies the chapter arrangement structure and the number of pages included in each bookmark.

The bookmark list 322 further includes a checkbox 323 displayed on the left of each of the one or more bookmarks.

Each bookmark changes a state where a bookmark is selected and a state where a selection of the bookmark is cancelled (e.g., a state where a bookmark is unselected) every time the bookmark is touched. For example, in the state where a bookmark is selected, a checkbox 323 displayed on the left of the corresponding bookmark is filled. In the state where the selection of the bookmark is cancelled, the filling in the checkbox 323 displayed on the left of the corresponding bookmark is cleared. In response to the selection of a bookmark, one or more pages corresponding to the selected bookmark are selected.

In a case where the bookmarks are displayed hierarchically, as a higher-level bookmark is selected, all of one or more lower-level bookmarks subordinate to the higher-level bookmark are selected and the checkboxes 323 displayed on the left of all the one or more lower-level bookmarks are filled respectively. As the selection of the higher-level bookmark is cancelled, the selection of all the one or more lower-level bookmarks subordinate to the higher-level bookmark are also cancelled and the filling in the checkboxes 323 displayed on the left of all the one or more lower-level bookmarks are cleared.

As a bookmark is selected, a pull-down button 324 and a page count of one or more pages corresponding to the bookmark appear on the right of the selected bookmark. In a case where the selected bookmark has subordinate bookmarks in a tree structure, the pull-down button 324 and the page count appear on the right of each of one or more lowest-level bookmarks subordinate to the selected bookmark. Even when the higher-level bookmark of the one or more selected lowest-level bookmarks is selected, the pull-down button 324 does not appear on the right of the higher-level bookmark.

Upon touching the pull-down button 324, a pull-down menu for selection of a print layout appears. The pull-down menu allows selection of a print layout from, for example, a 1 in 1 print layout (standard), a 2 in 1 print layout, and a 4 in 1 print layout. In a case where one of the 2 in 1 print layout and the 4 in 1 print layout is selected from the pull-down menu, the selected print layout is represented in text between the bookmark and the pull-down button 324. In a case where one of the 2 in 1 print layout and the 4 in 1 print layout is selected from the pull-down menu, a number of sheets to be used when printing is performed using the selected one of the 2 in 1 print layout and the 4 in 1 print layout appears on the right of the page count with being enclosed in parentheses.

In a case where a bookmark is not included in the file designated on the file selection screen 310, the bookmark selection screen 320 corresponding to the file does not allow the user to select one or more pages desired to be downloaded and printed. In this case, all pages included in the file are selected automatically as a target to be downloaded and printed. Then, the bookmark selection screen 320 displays a message indicating that “THIS FILE DOES NOT INCLUDE ANY BOOKMARK.” as shown in FIG. 3C. The bookmark selection screen 320 displays words “ALL PAGES” above the message with a fill-in checkbox 325 arranged on the left of the words. The bookmark selection screen 320 further displays a pull-down button 326 and the page count of all pages included in the file on the right of the words “ALL PAGES”.

Upon pressing the pull-down button 326, a pull-down menu for selection of a print layout appears. The pull-down menu allows selection of the print layout from, for example, the 1 in 1 print layout, the 2 in 1 print layout, and the 4 in 1 print layout. In a case where one of the 2 in 1 print layout and the 4 in 1 print layout is selected from the pull-down menu, the selected print layout appears in text on the left of the pull-down button 326. In a case where one of the 2 in 1 print layout and the 4 in 1 print layout is selected from the pull-down menu, the number of sheets to be used when printing is performed using the selected one of the 2 in 1 print layout and the 4 in 1 print layout appears on the right of the pages number enclosed in parentheses.

The bookmark selection screen 320 further displays an OK key 327 and a CANCEL key 328.

The bookmark selection screen 320 displays a total page count (e.g., a total sheet count) of the pages selected on all the bookmark selection screens 320, on the left of the OK key 327. That is, a sum of the number of pages selected in the PDF file “A” on the bookmark selection screen 320 shown in FIG. 3A, the number of pages selected in the PDF file “C” on the bookmark selection screen 320 shown in FIG. 3B, and the number of pages included in the PDF file “D” is displayed as the total page count. In other words, a sum of values in the page counts displayed on the respective bookmark selection screens 320 shown in FIGS. 3A, 3B, and 3C is displayed as the total page count. In a case where one of the 2 in 1 print layout and the 4 in 1 print layout is selected on the bookmark selection screen 320, that is, in a case where the number of sheets to be used is displayed on the right of the page count enclosed in parentheses, a total number of sheets to be used into which the page count is converted is displayed in parentheses.

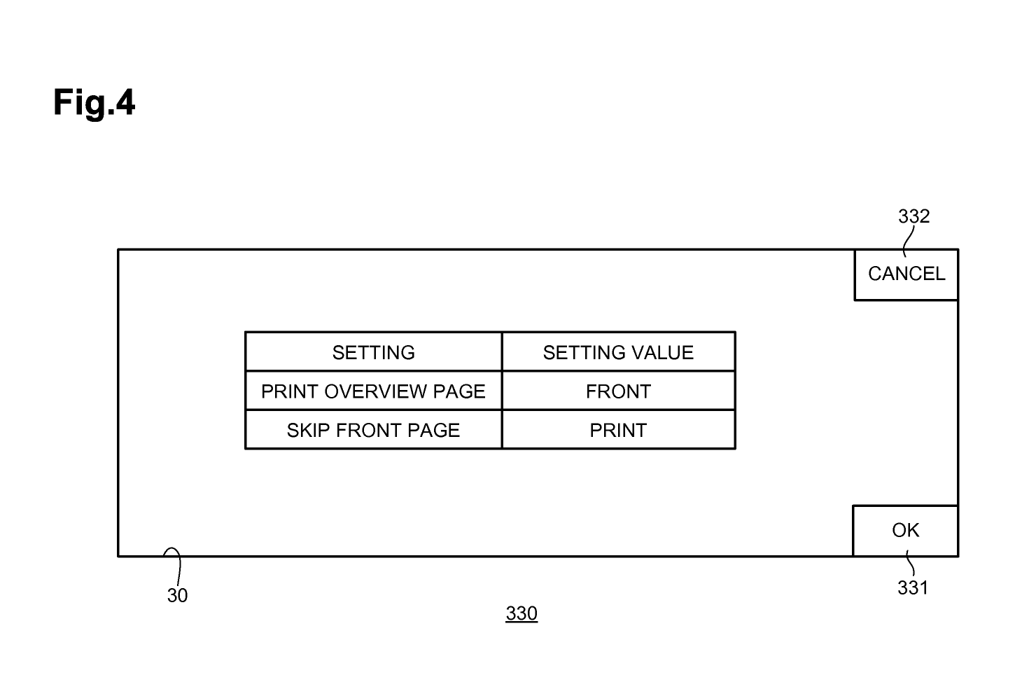

Upon touching the OK key 327 on one of the bookmark selection screens 320 after one or more pages to be downloaded and printed are selected or confirmed on each of the bookmark selection screens 320, the screen displayed on the touch panel of the operation panel 30 changes from the bookmark selection screen 320 to a first print-settings screen 330 shown in FIG. 4.

Upon touching the CANCEL key 328, the screen displayed on the touch panel of the operation panel 30 returns to the file selection screen 310 from the bookmark selection screen 320.

The first print-settings screen 330 allows settings of a print overview page and a skip front page.

The print overview page shows substantially the same contents as the contents displayed on each of the bookmark selection screens 320. The first print-settings screen 330 allows setting of whether a print overview page is printed. For printing the print overview page, the first print-settings screen 330 also allows setting of whether the print overview page is printed prior to or subsequent to the file to be downloaded and printed. The first print-settings screen 330 displays words “PRINT OVERVIEW PAGE” and a current setting value (e.g., a setting detail) related to the print overview page on the right of the words. In FIG. 4, a word “FIRST” is indicated as the current setting value. Upon touching the setting value, for example, a setting menu indicating the words “FIRST”, “LAST”, and “NOT PRINT” appears to allow change of the setting value. That is, by touching the word “FIRST” in the setting menu, the setting that the print overview page is printed prior to the file is specified. By touching the word “LAST”, the setting that the print overview page is printed subsequent to the file is specified. By touching the word “NOT PRINT”, the setting that the print overview page is not printed is specified.

The first print-settings screen 330 allows setting of whether a skip front page is printed. In the illustrative embodiment, one or more pages that have not been selected as a target to be downloaded and printed are referred to as “skip pages”. A first page of the one or more skip pages is referred to as a “skip front page”. The first print-settings screen 330 displays words “SKIP FRONT PAGE” and a current setting value on the right of the words. The current setting value indicates the setting of whether a skip front page is printed. Upon touching the setting value, a setting menu appears to allow specification of the setting of whether a skip front page is printed.

Instead of printing the skip front page, the bookmark corresponding to the skip front page may be printed.

The first print-settings screen 330 further displays an OK key 331 and a CANCEL key 332.

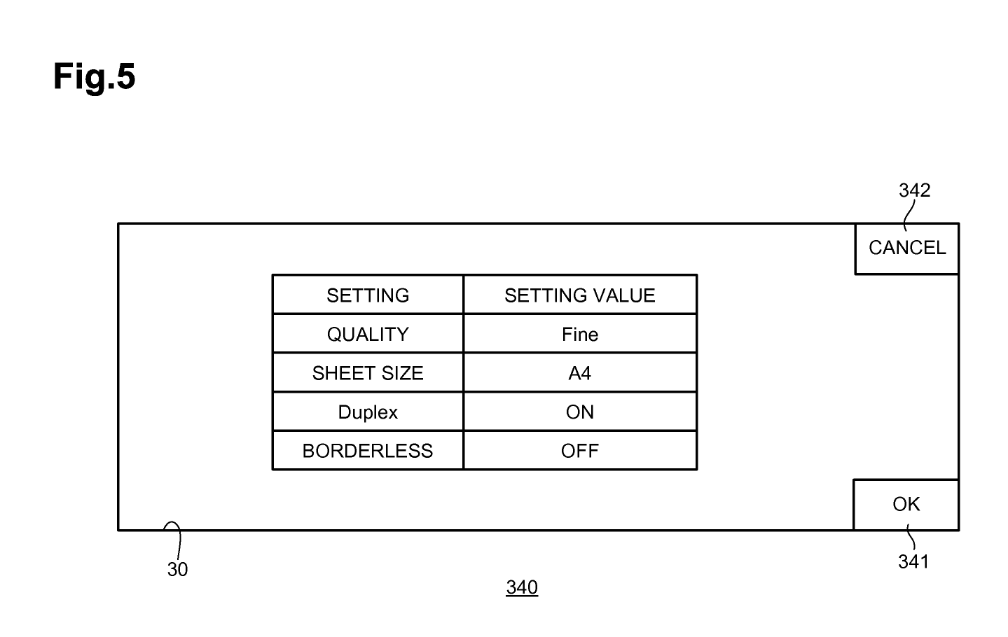

Upon touching the OK key 331, the screen displayed on the touch panel of the operation panel 30 changes from the first print-settings screen 330 to a second print-settings screen 340 shown in FIG. 5.

Upon touching the CANCEL key 332, the screen displayed on the touch panel of the operation panel 30 returns to the bookmark selection screen 320 from the first print-settings screen 330.

The second print-settings screen 340 allows settings of printing quality, size of printing sheets (sheet size), duplex printing, and borderless printing.

The second print-settings screen 340 displays a word “QUALITY” and a current setting value of the printing quality on the right of the word. Upon touching the setting value, a setting menu appears to allow selection of, for example, the printing quality between “FINE” and “NORMAL”.

The second print-settings screen 340 further displays a word “SHEET SIZE” below the word “QUALITY” and a current setting value of the sheet size is displayed on the right of the word “SHEET SIZE”. Upon touching the setting value, a setting menu appears to allow selection of, for example, the printing size between “A4” and “B5”.

The second print-settings screen 340 further displays a word “DUPLEX” below the word “SHEET SIZE” and a setting value indicating whether printing is performed on both sides of a printing sheet, on the right of the word “DUPLEX”. Upon touching the setting value, a setting menu appears to allow selection of whether printing is performed on both sides of a printing sheet.

The second print-settings screen 340 further displays a word “BORDERLESS” below the word “DUPLEX” and a setting value indicating whether a margin is provided around edges of a printing sheet, on the right of the word “BORDERLESS”. Upon touching the setting value, a setting menu appears to allow selection of whether a margin is provided around edges of a printing sheet.

The second print-settings screen 340 further displays an OK key 341 and a CANCEL key 342.

Upon touching the OK key 341, download printing starts based on the settings specified on the file selection screen 310, the bookmark selection screens 320, the first print-settings screen 330, and the second print-settings screen 340. The screen displayed on the touch panel of the operation panel 30 changes from the second print-settings screen 340 to a screen informing that printing is now performed (not shown).

Upon touching the CANCEL key 342, the screen displayed on the touch panel of the operation panel 30 returns to the first print-settings screen 330 from the second print-settings screen 340.

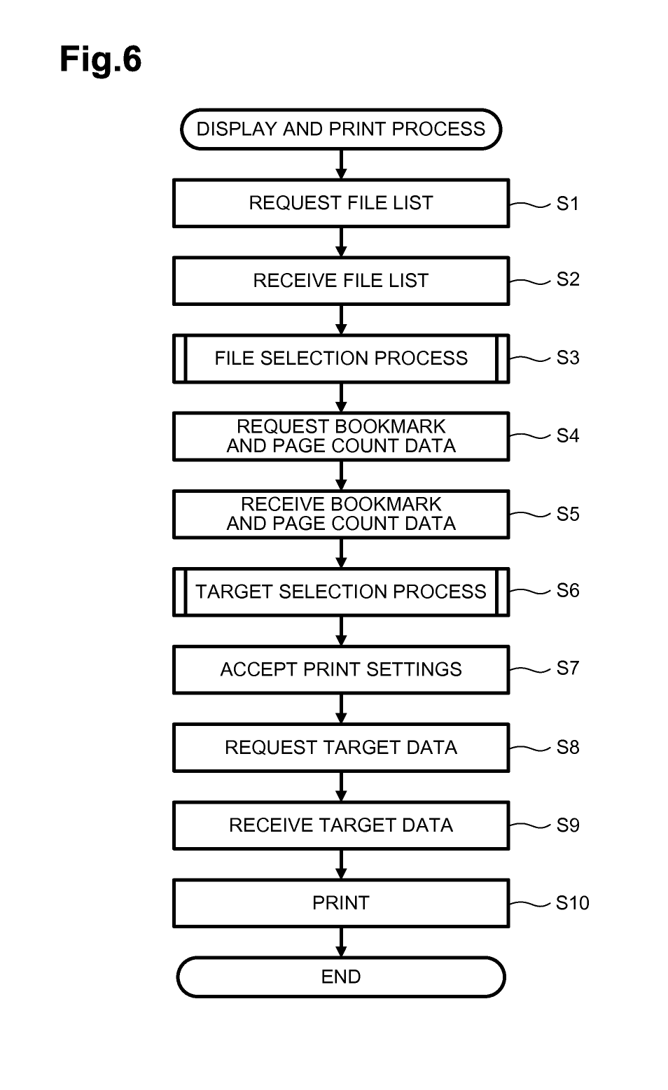

In response to the pressing of a download-and-print function selection button on the operation panel 30, the CPU 51 of the control device 50 performs a display and print process shown in FIG. 6.

In the display and print process, the CPU 51 requests transmission of a list of one or more files available for download and printing from the server 3 via the network interface 40 (e.g., step S1).

In response to the request, the server 3 transmits the file list. The CPU 51 receives the file list transmitted from the server 3 via the network interface 40 (e.g., step S2).

Then, the CPU 51 performs a file selection process for accepting selection of one or more files to be downloaded and printed (step S3). In the file selection process, the CPU 51 displays a file selection screen 310 (see FIG. 2) on the touch panel of the operation panel 30. Thereafter, the CPU 51 accepts selection of one or more files on the file selection screen 310. The file selection process will be described below.

After that, the CPU 51 requests data on one or more bookmarks included in the one or more files selected in the file selection process and a page count of one or more pages corresponding to each bookmark (e.g., step S4).

In response to the request, the server 3 transmits the data on the one or more bookmarks and of the page count. In a case where the one or more files do not include any bookmark, the data on the page count of all pages included in the one or more files is transmitted. The CPU 51 receives the data on the one or more bookmarks and the page count transmitted from the server 3 via the network interface 40 (e.g., step S5).

Then, the CPU 51 performs a target selection process for accepting selection of one or more pages to be downloaded and printed (e.g., step S6). In the target selection process, the CPU 51 displays a bookmark selection screen 320 (e.g., FIGS. 3A, 3B, and 3C) on the touch panel of the operation panel 30. Thereafter, the CPU 51 accepts selection of one or more pages on the bookmark selection screen 320. The target selection process will be described below.

Subsequent to the target selection process, the CPU 51 displays a first print-settings screen 330 shown in FIG. 4 and a second print-settings screen 340 shown in FIG. 5 on the touch panel of the operation panel 30. Then, the CPU 51 accepts various settings on the first print-settings screen 330 and the second print-settings screen 340 and stores the accepted settings in the RAM 53 (e.g., step S7).

Thereafter, the CPU 51 requests image data (print target data) of the one or more pages selected as one or more targets to be downloaded and printed on the bookmark selection screen 320 from the server 3 (e.g., step S8).

In response to the request, the server 3 transmits the print target data. The CPU 51 receives the print target data transmitted from the server 3 via the network interface 40 (e.g., step S9).

Thereafter, the CPU 51 controls the image forming portion 10 to print the print target data received from the server 3 (e.g., step S10). When the setting that a print overview page is printed is specified on the first print-settings screen 330 shown in FIG. 4, the CPU 51 controls the image forming portion 10 to print the print overview page. When the setting that a skip front page is printed is specified on the first print-settings screen 330 shown in FIG. 4, the CPU 51 controls the image forming portion 10 to print the skip front page. Then, the CPU 51 ends the display and print process.

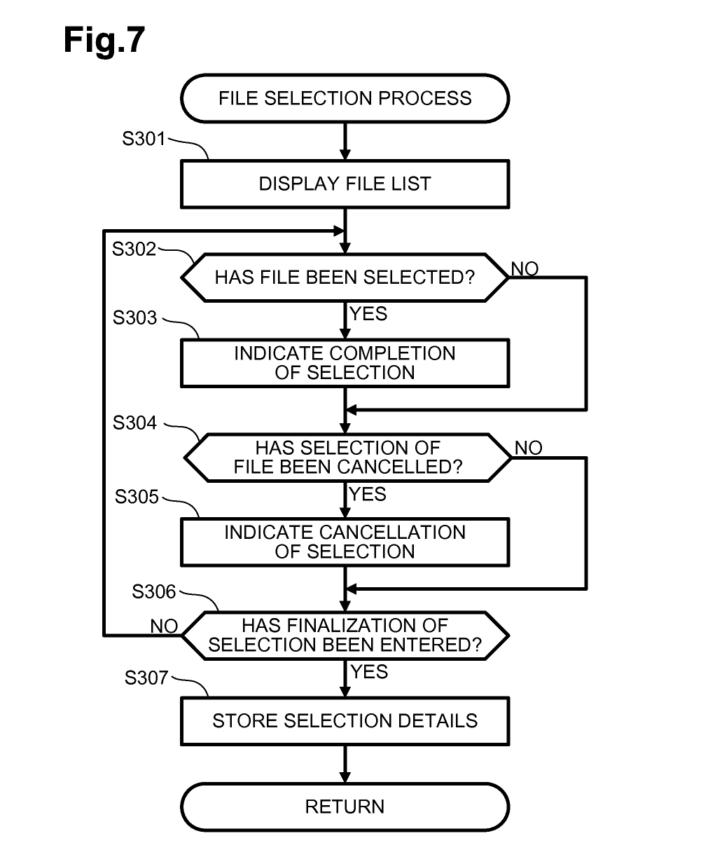

Steps in the file selection process are shown in FIG. 7.

In the file selection process, the CPU 51 displays a file selection screen 310 (see FIG. 2) on the touch panel of the operation panel 30 based on the list of one or more files available for download and printing received from the server 3 (e.g., step S301).

During display of the file selection screen 310, the CPU 51 repeatedly determines whether an icon 311 has been touched on the file selection screen 310 (e.g., step S302).

Upon touching an icon 311, the CPU 51 determines that a file corresponding to the icon 311 is selected (e.g., YES in step S302). The CPU 51 indicates that the file corresponding to the icon 311 has been selected by enclosing the touched icon 311 in the quadrangle indicated by the dashed line, on the file selection screen 310 (e.g., step S303).

During display of the file selection screen 310, the CPU 51 repeatedly determines whether the icon 311 corresponding to the selected file, that is, the icon 311 enclosed in the quadrangle indicated by the dashed line, has been touched (e.g., step S304).

Upon touching the icon 311 enclosed in the quadrangle indicated by the dashed line, the CPU 51 determines that the selection of the file corresponding to the icon 311 is canceled (e.g., YES in step S304). The CPU 51 indicates that the selection of the file corresponding to the icon 311 has been cancelled by dismissing the indication of the quadrangle indicated by the dashed line (e.g., step S305).

During display of the file selection screen 310, the CPU 51 repeatedly determines whether the OK key 312 has been touched on the file selection screen 310 (e.g., step S306).

Upon touching the OK key 312, the CPU 51 determines that finalization of the selection of the one or more files is entered (e.g., YES in step S306). The CPU 51 finalizes the selection of the one or more files and stores the selection result in the RAM 53 (e.g., step S307). Thereafter, the routine returns to the main routine from the file selection process.

Upon touching the CANCEL key 313 on the file selection screen 310, the CPU 51 closes the file selection screen 310 on the touch panel, and the routine returns to the main routine from the file selection process.

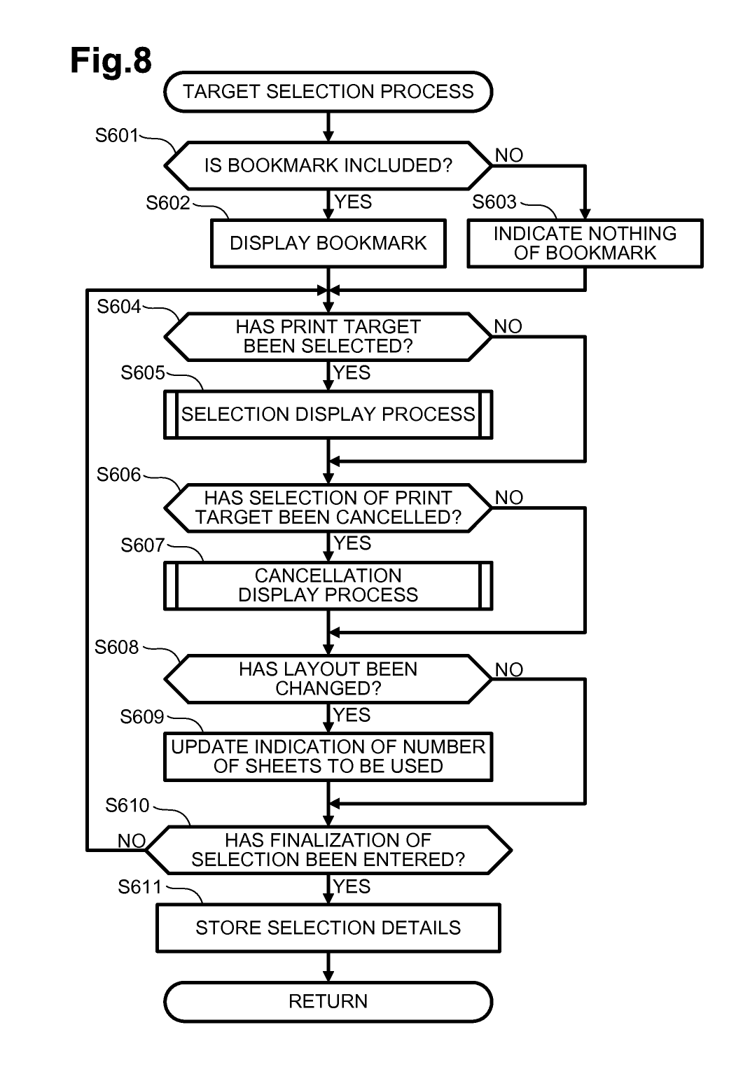

Steps in the target selection process are shown in FIG. 8.

In the target selection process, the CPU 51 determines whether a bookmark is included in the data received from the server 3 (e.g., step S601).

When a bookmark is included (e.g., YES in step S601), the CPU 51 displays a bookmark selection screen 320 including a bookmark list 322 (see FIGS. 3A and 3B) on the touch panel of the operation panel 30 based on the data received from the server 3 (e.g., step S602).

When no bookmark is included in the data received from the server 3 (e.g., NO in step S601), the CPU 51 displays, on the touch panel of the operation panel 30, a bookmark selection screen 320 (see FIG. 3C) including a message indicating that there is no bookmark, for example, “THIS FILE DOES NOT INCLUDE ANY BOOKMARK.” (e.g., step S603).

During display of the bookmark selection screen 320, the CPU 51 repeatedly determines whether a bookmark has been touched on the bookmark selection screen 320 (e.g., step S604).

Upon touching a bookmark (e.g., YES in step S604), the CPU 51 performs a selection display process for indicating that a bookmark has been selected on the bookmark selection screen 320 (e.g., step S605). The selection display process will be described below.

During display of the bookmark selection screen 320, the CPU 51 repeatedly determines whether the selected bookmark has been touched (e.g., step S606).

Upon touching the selected bookmark (e.g., YES in step S606), the CPU 51 performs a cancellation display process for indicating that the selection of the bookmark has been cancelled on the bookmark selection screen 320 (e.g., step S607). The cancellation display process will be described below.

During display of the bookmark selection screen 320, the CPU 51 repeatedly determines whether the pull-down button 324 has been touched on the bookmark selection screen 320. Upon touching the pull-down button 324, the CPU 51 displays a pull-down menu for selection of a print layout on the bookmark selection screen 320. Then, the CPU 51 determines whether the setting of the print layout has been changed by the selection of another print layout from the pull-down menu (e.g., step S608).

When the setting of the print layout has been changed (e.g., YES in step S608), the CPU 51 updates the indication of the number of sheets to be used in parentheses on the bookmark selection screen 320 (e.g., step S609).

During display of the bookmark selection screen 320, the CPU 51 repeatedly determines whether the OK key 327 has been touched on the bookmark selection screen 320 (e.g., step S610).

Upon touching the OK key 327, the CPU 51 determines that finalization of the selection of the one or more pages is entered (e.g., YES in step S610). The CPU 51 finalizes the selection of the one or more pages and stores the selection result in the RAM 53 (e.g., step S611). Then, the routine returns to the main routine from the target selection process.

Upon touching the CANCEL key 328 of the bookmark selection screen 320, the CPU 51 closes the bookmark selection screen 320 on the touch panel and routine returns to the main routine from the target selection process.

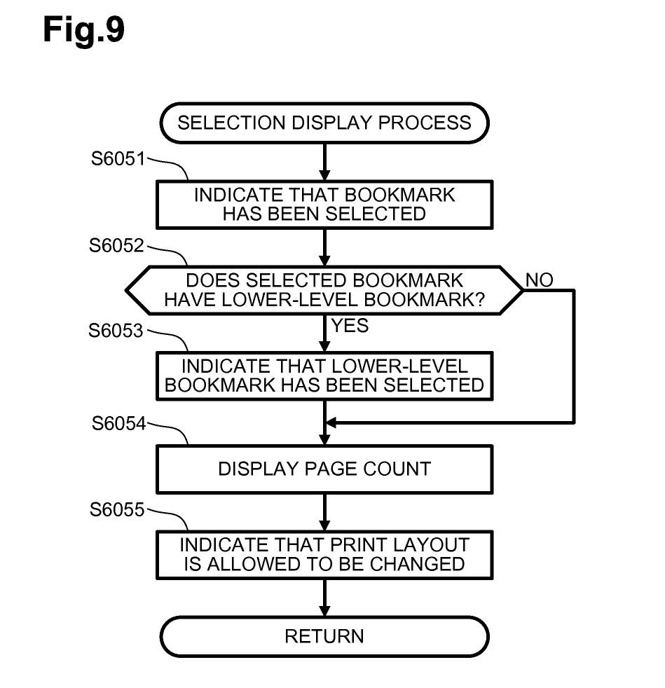

Steps in the selection display process are shown in FIG. 9.

In the selection display process, the CPU 51 indicates that the bookmark has been selected in a manner that the checkbox 323 on the left of the bookmark touched on the bookmark selection screen 320 is filled (e.g., step S6051).

Then, the CPU 51 determines whether the touched bookmark has one or more lower-level bookmarks subordinate thereto (e.g., step S6052).

When the touched bookmark has one or more lower-level bookmarks subordinate thereto (e.g., YES in step S6052), the CPU 51 indicates that the one or more subordinate bookmarks have been selected in a manner that the checkbox 323 on the left of the corresponding one of the one or more subordinate bookmarks is filled (e.g., step S6053).

When the touched bookmark does not have any lower-level bookmark subordinate thereto (e.g., NO in step S6052), the CPU 51 skips processing of step S6053.

Then, the CPU 51 displays the page count of one or more pages corresponding to each of the one or more lowest-level bookmarks of the selected bookmark on the bookmark selection screen 320 (e.g., step S6054).

The CPU 51 displays a pull-down button 324 on the right of each of the one or more lowest-level bookmarks of the selected bookmark to indicate that the print layout is allowed to be changed from the pull-down menu, on the bookmark selection screen 320 (e.g., step S6055). Then, the routine returns to the main routine from the selection display process.

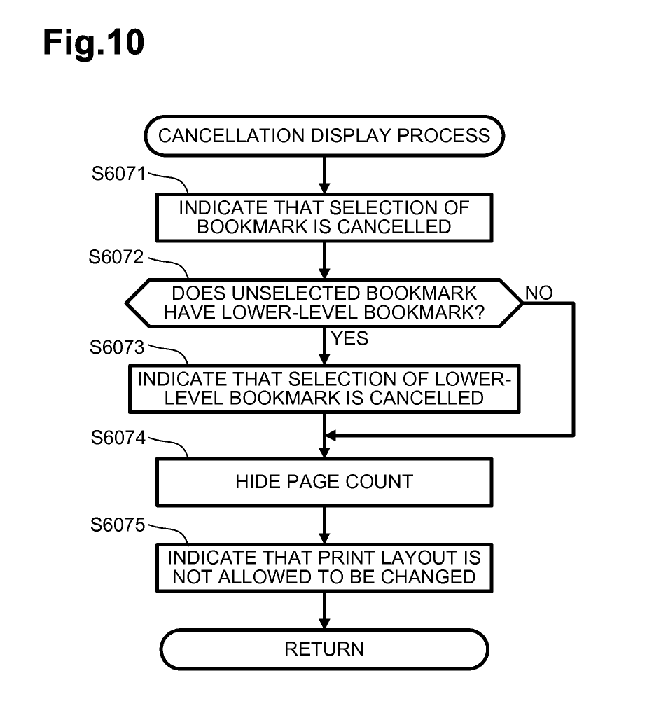

Steps in the cancellation display process are shown in FIG. 10.

In the cancellation display process, the CPU 51 indicates that the selection of the bookmark has been cancelled in a manner that the filling of the checkbox 323 on the left of the corresponding bookmark touched on the bookmark selection screen 320 is cleared (e.g., step S6071).

Then, the CPU 51 determines whether the touched bookmark has one or more lower-level bookmarks subordinate thereto (e.g., step S6072).

When the touched bookmark has one or more lower-level bookmarks subordinate thereto (e.g., YES in step S6072), the CPU 51 indicates that the selection of the one or more subordinate bookmarks has been cancelled in a manner that the filling of the checkbox 323 on the left of the corresponding one of the one or more subordinate bookmarks is cleared (e.g., step S6073).

When the touched bookmark does not have any lower-level bookmark subordinate thereto (e.g., NO in step S6072), the CPU 51 skips processing of step S6073.

Then, the CPU 51 hides the page count of one or more pages corresponding to each of the one or more lowest-level bookmarks of the unselected bookmark, on the bookmark selection screen 320 (e.g., step S6074).

The CPU 51 hides the pull-down button 324 displayed on the right of each of the lowest-level bookmarks of the cancelled bookmark to indicate that the print-layout change is not allowed, on the bookmark selection screen 320 (e.g., step S6075). Then, the routine returns to the main routine from the cancellation display process.

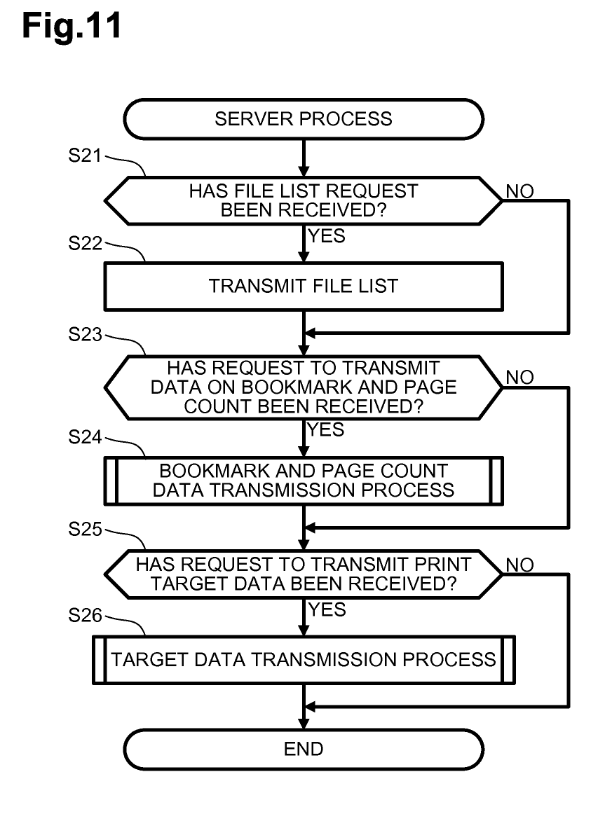

The server 3 repeatedly performs a server process shown in FIG. 11 to offer the download service.

In the server process, the server 3 determines whether the server 3 is requested to transmit a list of one or more files available for download and printing from the MFP 1 (e.g., step S21). This request is outputted by the MFP 1 in the processing of step S1 of the display and print process shown in FIG. 6.

Upon receipt of the request of the transmission of the file list (e.g., step S21:YES), the server 3 identifies one or more files available for download and printing by the MFP 1 in the files stored in the server 3 and transmits the one or more identified files to the MFP 1 (e.g., step S22).

When the server 3 is not requested to transmit the file list (e.g., NO in step S21), the server 3 skips processing of step S22.

Then, the server 3 determines whether the server 3 is requested to transmit data on one or more bookmarks and page count from the MFP 1 (e.g., step S23). This request is outputted by the MFP 1 in the processing of step S4 of the display and print process shown in FIG. 6.

Upon receipt of the request to transmit the one or more bookmarks and the page count (e.g., YES in step S23), the server 3 performs a bookmark and page count data transmission process for transmitting data on one or more bookmarks and page count (e.g., step S24).

When the server 3 is not requested to transmit the one or more bookmarks and the page count (e.g., NO in step S23), the server 3 skips the bookmark and page count data transmission process.

The server 3 determines whether the server 3 is requested to transmit print target data from the MFP 1 (e.g., step S25).

Upon receipt of the request for transmission of the print target data (e.g., YES in step S25), the server 3 performs a target data transmission process for transmitting print target data (e.g., step S26) and ends the server process.

When the server 3 is not requested to transmit the print target data (e.g., NO in step S25), the server 3 skips the target data transmission process and ends the server process.

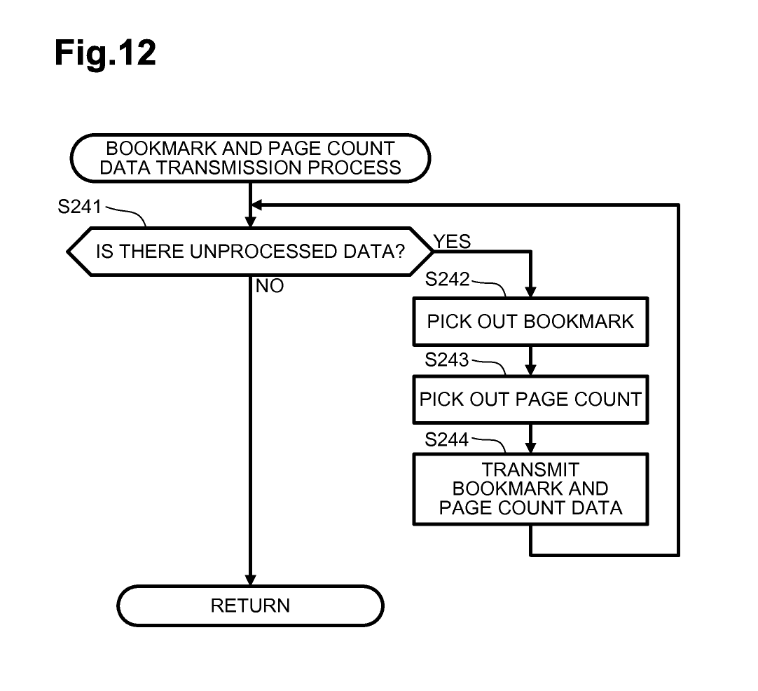

Steps in the bookmark and page count data transmission process are shown in FIG. 12.

In the bookmark and page count data transmission process, the server 3 determines whether there is an unprocessed file in the one or more files including the one or more bookmarks requested by the MFP 1 (e.g., step S241).

When there is an unprocessed file (e.g., YES in step S241), the server 3 attempts to pick out one or more bookmarks from the unprocessed file (step S242).

When the picking of the one or more bookmarks has succeeded, the server 3 picks out a page count of one or more pages corresponding to each of the one or more picked bookmarks (e.g., step S243). When the picking of the one or more bookmarks has failed, that is, when the file does not have any bookmark, the CPU 51 picks out a page count of all pages included in the file (e.g., step S243).

When the picking of the one or more bookmarks has succeeded, the server 3 transmits data on the one or more bookmarks and the page count corresponding to each of the one or more bookmarks to the MFP 1 (e.g., step S244). When the picking of the one or more bookmarks has failed, the server 3 transmits only data on the page count to the MFP 1 (e.g., step S244).

Thereafter, the server 3 determines again whether there is an unprocessed file (e.g., step S241). When there is an unprocessed file (e.g., YES in step S241), the CPU 51 performs the processing of steps S242 to S244.

When there is no unprocessed file (e.g., NO in step S241), the server 3 ends the bookmark and page count data transmission process.

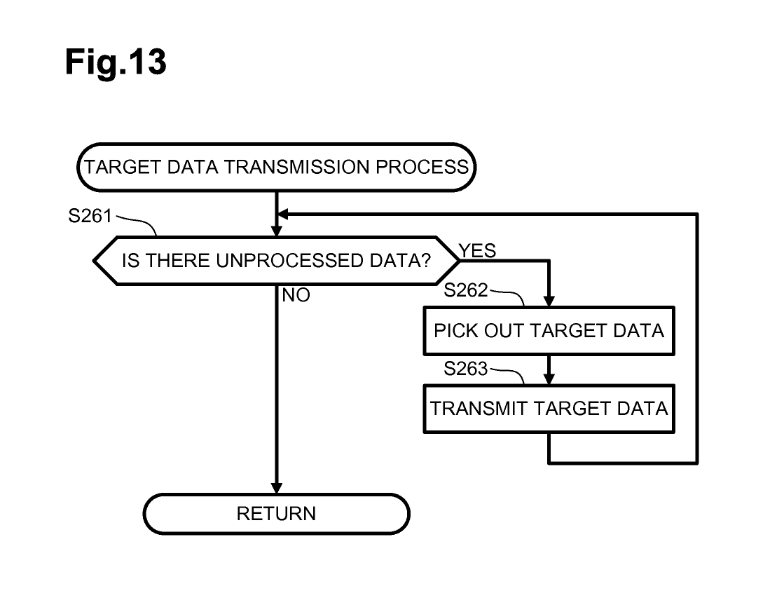

Steps in the target data transmission process are shown in FIG. 13.

In the target data transmission process, the server 3 determines whether there is an unprocessed file in the one or more files including the print target data requested by the MFP 1 (e.g., step S261).

When there is an unprocessed file (e.g., YES in step S261), the server 3 picks out print target data from the unprocessed file (e.g., step S262).

Then, the server 3 transmits the print target data picked out from the unprocessed file to the MFP 1 (e.g., step S263).

When a size of the unprocessed file is large, the server 3 divides the file into a plurality of portions and picks out print target data from each of the plurality of divided portions. Then, the server 3 transmits the print target data to the MFP 1 on a divided-portion basis.

After that, the server 3 again determines whether there is an unprocessed file (e.g., step S261). When there is an unprocessed file (e.g., YES in step S261), the server 3 performs the processing of steps S262 and S263 described above.

When there is no more unprocessed file (e.g., NO in step S261), the server 3 ends the target data transmission process.

As described above, one or more bookmarks included in a file available for download and printing are obtained from the server 3, and the one or more obtained bookmarks are displayed on the operation panel 30. Therefore, the user may identify one or more pages to be printed easily by referring to the one or more bookmarks displayed on the operation panel 30. Then, the user may select and designate one or more of the one or more bookmarks corresponding to the one or more pages to be printed via the operation panel 30. As one or more bookmarks are designated, image data (print target data) of one or more pages corresponding to the one or more designated bookmarks is obtained from the server 3 and then printed. Therefore, the trouble associated with page designation printing may be reduced. Further, an unreasonable operation of obtaining image data of one or more pages that are unnecessary to be printed from the server 3 may be omitted. Thus, the time required to obtain image data from the server 3 may be shortened.

In a case where a plurality of files available for download and printing is selected, a plurality of bookmarks corresponding to the plurality of files is displayed on the operation panel 30. Therefore, the user may select and designate one or more bookmarks of the plurality of files via the operation panel 30. As one or more bookmarks of the plurality of files are designated, image data of one or more pages corresponding to the one or more bookmarks of each file is printed. Therefore, in a case where one or more pages of each of the plurality of files are designated and printed, it is unnecessary to designate one or more bookmarks in each file. Thus, usability may be increased and the trouble associated with page designation printing may be further reduced.

The page count corresponding to each bookmark is displayed on the operation panel 30 as well as the bookmarks. In this case, the user may use the page count corresponding to each bookmark as one of materials for determining whether one or more pages corresponding to the bookmark are to be printed by referring to the indication on the operation panel 30.

In a case where a file is a document file that represents a document arranged into chapters, a plurality of bookmarks are displayed hierarchically on the operation panel 30 in order for the user to understand the chapter arrangement structure (hierarchical structure). Thus, the user may identify one or more pages to be printed more easily. Accordingly, the trouble associated with page designation printing may be further reduced.

When a higher-level bookmark is designated, one or more lower-level bookmarks subordinate to the higher-level bookmark are also designated. Therefore, this configuration does not require the further designation of the one or more lower-level bookmarks subordinate to the higher-level bookmark that is designated. Accordingly, the usability and convenience may be improved.

At least one of the total page count and the total number of sheets to be used corresponding to the one or more bookmarks designated by the user is displayed on the operation panel 30. Thus, the user may be acquainted with the at least one of the total page count and the total number of sheets to be used, thereby improving the convenience.

When the setting that a print overview page is printed is specified on the first print-settings screen 330 shown in FIG. 4, the print overview page is printed. When the setting that a skip front page is printed is specified on the first print-settings screen 330 shown in FIG. 4, the skip front page is printed. The user may grasp the details (the structure) of the whole file through the print overview page and/or the skip front page, thereby improving the convenience.

Hereinabove, the description has been made on the illustrative embodiment. Nevertheless, the invention may be implemented by other embodiments.

The process for performing printing with one or more pages included in one or more files being designated has been described by taking the download printing as an example. Nevertheless, for example, printing using direct print function (direct printing) may be performed by the same processing. The MFP 1 having the direct print function comprises a connection port for external device, such as a USB port (e.g., USB interface), for connecting removable media to the MFP 1. In this case, the processing of steps S1, S2, S4, S5, S8, and S9 of the display and print process shown in FIG. 6 are omitted, and the CPU 51 reads out a file list, data on one or more bookmarks and page count, and print target data from the removable media.

In the above-described illustrative embodiment, the case where the CPU 51 performs the processes has been described. Nevertheless, the ASIC 55 may perform the processes or the CPU 51 and the ASIC 55 may perform the processes in conjunction with each other. The control device 50 may comprise a plurality of CPUs, and the plurality of CPUs may perform the processes in conjunction with each other.

A program for performing the processes (e.g., the display and print process) performed by the CPU 51 of the MFP 1 may be installed on a computer (PC) 4 connected to the Internet 2, and the same processes as the processes performed by the CPU 51 may be performed by the PC 4. In this case, the file selection screen 310, the bookmark selection screen 320, the first print-settings screen 330, and the second print-settings screen 340 are displayed on a display (not shown) connected to the PC 4.

The destination to install the program for performing the processes (e.g., the display and print process) performed by the CPU 51 of the MFP 1 might not be limited to the PC 4 connected to the Internet 2, but in other embodiments, the program may be installed on a PC (not shown) connected to the MFP 1 via a local area network (“LAN”). The same processes as the processes performed by the CPU 51 may be performed by the PC.

In the above-described illustrative embodiment, the PDF-format file (PDF file) has been taken as an example of a file including one or more bookmarks. Nevertheless, in addition to the PDF format, a Word format, an XML Paper Specification (“XPS”) format, and a PostScript format (“PS”) may also be examples of the format of the file including the one or more bookmarks.

In the above-described embodiments, one or more bookmarks included in a file are designated and image data of one or more designated pages are captured into the MFP 1 from the server 3 or the removable media. Nevertheless, in other embodiments, for example, as the user designates one or more page numbers of one or more pages desired to be printed, image data representing the one or more designated pages may be selected from image data included in the file and the selected image data may be captured into the MFP 1 from the server 3 or the removable media. That is, the technique of selecting image data representing one or more designated pages from image data included in a file and capturing the selected image data from an external device into the MFP 1 in response to designation of the one or more pages included in the file using page-identifiable information, such as one or more bookmarks or page numbers may be widely applied to devices having the print function. According to this technique, an unreasonable operation of obtaining image data of one or more pages that are unnecessary to be printed by the device having the print function from the external device may be omitted. Therefore, the time required to obtain the selected image data from the server 3 may be shortened.

Various design changes, arrangements and modifications may be applied to the above-described configurations within the scope claimed in claims.

What is claimed is:

1. A printing apparatus comprising:
a display device;
a printing device;
a processor; and
memory storing instructions therein, the instructions, when executed by the processor, causing the printing apparatus to perform steps comprising:
displaying a bookmark associated with a file on the display device;
accepting designation of the bookmark displayed on the display device;
obtaining image data of one or more pages from the file associated with the designated bookmark; and
controlling the printing device to print the obtained image data.

2. The printing apparatus according to claim 1, wherein displaying the bookmark associated with the file on the display device comprises displaying a plurality of bookmarks associated with the file on the display device,
wherein accepting the designation of the bookmark displayed on the display device comprises accepting designation of at least two bookmarks of the plurality of bookmarks displayed on the display device,
wherein obtaining the image data of the one or more pages from the file associated with the designated bookmark comprises obtaining image data of each page from the file associated with the designated at least two bookmarks, and
wherein controlling the printing device to print the obtained image data comprises controlling the printing device to print the obtained image data of each page associated with the designated at least two bookmarks.

3. The printing apparatus according to claim 1, wherein the instructions, when executed by the processor, further cause the printing apparatus to perform steps comprising:
displaying a bookmark associated with a second file on the display device;
accepting designation of the bookmark associated with the second file displayed on the display device; and
obtaining the image of one or more pages from the second file associated with the designated bookmark associated with the second file,
wherein controlling the printing device includes controlling the printing device to print the obtained image data of the file and the second file.

4. The printing apparatus according to claim 1, wherein the instructions, when executed by the processor, further cause the printing apparatus to perform a step comprising displaying, on the display device, at least one of a total page count of pages associated with each designated bookmark and a total number of sheets to be used for printing the one or more pages associated with each designated bookmark.

5. The printing apparatus according to claim 1, wherein the instructions, when executed by the processor, further cause the printing apparatus to perform steps comprising:
displaying a page count of a number of pages associated with the designated bookmark on the display device.

6. The printing apparatus according to claim 1, wherein the instructions, when executed by the processor, further cause the printing apparatus to perform steps comprising:
displaying on the display device a number of sheets on which a number of pages associated with the designated bookmark are set to printed.

7. The printing apparatus according to claim 1, wherein the instructions, when executed by the processor, further cause the printing apparatus to perform steps comprising:
displaying on the display device a number of pages that are set to be printed on a single sheet.

8. The printing apparatus according to claim 1, wherein displaying the bookmark associated with the file on the display device comprises displaying a plurality of bookmarks associated with the file on the display device,
wherein accepting the designation of the bookmark displayed on the display device comprises accepting designation of one or more bookmarks of the plurality of bookmarks displayed on the display device,
wherein the instructions, when executed by the processor, further cause the printing apparatus to perform a step comprising:
controlling the printing device to print information identifying one or more pages associated with one or more bookmarks that are not designated.

9. The printing apparatus according to claim 1, wherein the instructions, when executed by the processor, further cause the printing apparatus to perform a step comprising controlling the printing device to print a bookmark list displayed on the display device.

10. The printing apparatus according to claim 1, wherein displaying the bookmark associated with the file on the display device comprises displaying hierarchically a plurality of bookmarks associated with the file on the display device.

11. The printing apparatus according to claim 10, wherein the instructions, when executed, further cause the printing apparatus to perform a step comprising designating each lower-level bookmark subordinate to a higher-level bookmark when the higher-level bookmark is designated.

12. The printing apparatus according to claim 1, wherein the instructions, when executed by the processor, further cause the printing apparatus to perform a step comprising displaying, on the display device, at least one of a total page count of pages associated with the designated bookmark and a total number of sheets to be used for printing the one or more pages associated with the designated bookmark.

13. The printing apparatus according to claim 1, wherein the file is stored in an external device,
wherein the instructions, when executed, further cause the printing apparatus to perform a step comprising obtaining the bookmark from the external device,
wherein displaying the bookmark associated with the file on the display device comprises displaying the bookmark obtained from the external device on the display device, and
wherein obtaining the image data of the one or more pages from the file associated with the designated bookmark comprises obtaining, from the external device, image data of one or more pages associated with the designated bookmark.

14. The printing apparatus according to claim 1, further comprising an operation device, wherein the step of accepting designation of the bookmark includes accepting designation of the bookmark via the operation device.

15. A non-transitory computer-readable storage medium storing instructions therein, the instructions, when executed, causing a computer that comprises a display device and is configured to be connected to a printing apparatus, to perform steps comprising:
displaying a bookmark associated with a file on the display device;
accepting designation of the bookmark displayed on the display device;
obtaining image data of one or more pages from the file associated with the designated bookmark; and
controlling the printing apparatus to print the obtained image data.

16. The non-transitory computer-readable storage medium according to claim 15, wherein displaying the bookmark associated with the file on the display device comprises displaying a plurality of bookmarks associated with the file on the display device,
wherein accepting the designation of the bookmark displayed on the display device comprises accepting designation of at least two bookmarks of the plurality of bookmarks displayed on the display device,
wherein obtaining the image data of the one or more pages from the file associated with the designated bookmark comprises obtaining image data of each page from the file associated with the designated at least two bookmarks, and
wherein controlling the printing apparatus to print the obtained image data comprises controlling the printing apparatus to print the obtained image data of each page associated with the designated at least two bookmarks.

17. The non-transitory computer-readable storage medium according to claim 15, wherein the instructions, when executed, further cause the computer to perform steps comprising:
displaying a bookmark associated with a second file on the display device;
accepting designation of the bookmark associated with the second file displayed on the display device; and
obtaining the image of one or more pages from the second file associated with the designated bookmark associated with the second file,
wherein controlling the printing apparatus includes controlling the printing apparatus to print the obtained image data of the file and the second file.

18. A method comprising:
displaying a bookmark associated with a file on a display device;
accepting designation of the bookmark displayed on the display device;
obtaining image data of one or more pages from the file associated with the designated bookmark; and
controlling a printing apparatus to print the obtained image data.

19. The method according to claim 18, wherein displaying the bookmark associated with the file on the display device comprises displaying a plurality of bookmarks associated with the file on the display device,
wherein accepting the designation of the bookmark displayed on the display device comprises accepting designation of at least two bookmarks of the plurality of bookmarks displayed on the display device,
wherein obtaining the image data of the one or more pages from the file associated with the designated bookmark comprises obtaining image data of each page from the file associated with the designated at least two bookmarks, and
wherein controlling the printing apparatus to print the obtained image data comprises controlling the printing apparatus to print the obtained image data of each page associated with the designated at least two bookmarks.

20. The method according to claim 18 further comprising:
displaying a bookmark associated with a second file on the display device;
accepting designation of the bookmark associated with the second file displayed on the display device; and
obtaining the image of one or more pages from the second file associated with the designated bookmark associated with the second file,
wherein controlling the printing apparatus includes controlling the printing apparatus to print the obtained image data of the file and the second file.
